(19) United States
(12) Patent Application Publication
(10) Pub. No.: US 2018/0376015 A1
(43) Pub. Date: Dec. 27, 2018

(54) IMAGE FORMING APPARATUS WITH PERSONALIZATION FUNCTION, CONTROL METHOD THEREFOR, AND STORAGE MEDIUM

(71) Applicant: CANON KABUSHIKI KAISHA, Tokyo (JP)

(72) Inventor: Takeshi Hokiyama, Yokohama-shi (JP)

(21) Appl. No.: 16/003,695

(22) Filed: Jun. 8, 2018

(30) Foreign Application Priority Data
Jun. 27, 2017 (JP) 2017-125225

(51) Int. Cl. H04N 1/00; G06F 3/12

(52) U.S. Cl. CPC H04N 1/00514; H04N 1/00411; G06F 3/1204; G06F 3/1256

(57) ABSTRACT

An image forming apparatus which is capable of offering user-identifying IDs suitable for an environment. The image forming apparatus holds job data received from an external apparatus operated by a user, and in accordance with an instruction given by the user, executes the job data. Based on user-related information related to the user and included in the job data, a user-identifying ID for managing the job data is generated. The user sets information relating to a configuration of the user-identifying ID. In a case where the job data includes a domain name indicating a domain used by the external apparatus and a user name indicating the user that has operated the external apparatus as the user-related information, a first user-identifying ID comprised of the domain name and the user name or a second user-identifying ID comprised of only the user name is generated based on the setting information.

### BACKGROUND OF THE INVENTION

### Field of the Invention

The present invention relates to an image forming apparatus, a control method therefor, and a storage medium.

### Description of the Related Art

An MFP which is an image forming apparatus with a personalization function is known. In the MFP, the personalization function is used when a user is prompted to choose print data that is held in the MFP for the purpose of reservation printing. In the MFP, icon images for respective users are displayed on a display unit of the MFP, and information on a list of print data associated with a selected icon image is displayed (see, for example, Japanese Laid-Open Publication (Kokai) No. 2012-254618). Upon receiving print data for use in reservation printing from a PC or the like, the MFP analyzes the print data and obtains a user name indicating a user who has given an instruction to send the print data. The MFP associates the received print data and an icon image with the obtained user name.

The MFP is used in various office environments, and in some cases, used in an office environment where uniqueness of user names of respective users who use the MFP is not managed. In this case, if user names of different users match, a problem that print data sent by the different users is associated with the matching user names would occur. To address this problem, when receiving print data from a PC or the like, the MFP obtains a computer name indicating the PC that is a sender of the print data and a domain name indicating a domain used by the PC. The MFP combines either of the obtained computer name and domain name with a user name to generate a user-identifying ID (see, for example, Japanese Laid-Open Publication (Kokai) No. 2016-25417). This prevents occurrence of the above described problem because in an office environment where uniqueness of user names of respective users who use the MFP is not managed, unique user-identifying IDs for the respective users are generated. The conventional MFP thus offers the user-identifying ID suitable for a user's office environment.

However, there may be cases where the conventional MFP cannot offer user-identifying IDs suitable for the user's office environment. For example, in an office environment where uniqueness of user names of respective users who use the MFP is managed, the above described problem never occurs even if a user-identifying ID comprised of only a user name is used, but even in this office environment, the conventional MFP generates a user-identifying ID by combining either of a computer name and a domain name with a user name. As a result, a plurality of user-identifying IDs with different computer names and domain names are generated for the same user, and a plurality of icon images associated with the respective user-identifying IDs is displayed, making the display of the icon images complicated.

### SUMMARY OF THE INVENTION

The present invention provides an image forming apparatus and a control method therefor which are capable of offering user-identifying IDs suitable for an environment, as well as a storage medium.

Accordingly, the present invention provides an image forming apparatus that holds job data received from an external apparatus operated by a user, and in accordance with an instruction given by the user, executes the job data, comprising a generating unit configured to, based on user-related information related to the user and included in the received job data, generate a user-identifying ID for managing the job data, and a setting unit configured to prompt the user to set setting information relating to a configuration of the user-identifying ID, wherein in a case where the received job data includes a domain name indicating a domain used by the external apparatus and a user name indicating the user who has operated the external apparatus as the user-related information, the generating unit generates a first user-identifying ID comprising the domain name and the user name or a second user-identifying ID comprising only the user name based on the setting information.

According to the present invention, user-identifying IDs suitable for an environment are offered.

Further features of the present invention will become apparent from the following description of exemplary embodiments (with reference to the attached drawings).

### BRIEF DESCRIPTION OF THE DRAWINGS

FIG. 1 is a network diagram schematically showing an arrangement of a printing system including an MFP which is an image forming apparatus according to an embodiment of the present invention.

FIG. 2 is a view showing an example of print data that is sent from a PC in FIG. 1.

FIG. 3A is a view showing an example of an operating screen displayed on an operating unit in FIG. 1.

FIG. 3B is a view showing an example of a user selection screen displayed on the operating unit in FIG. 1.

FIG. 4 is a block diagram schematically showing an arrangement of software modules of the MFP in FIG. 1.

FIG. 5 is a view showing an example of user management information that is managed by a user management module in FIG. 4.

FIG. 6 is a view showing an example of a management list that is managed by an application management module in FIG. 4.

FIG. 7 is a timing chart showing the procedure of a reservation printing process that is carried out by the printing system in FIG. 1.

FIG. 8 is a flowchart showing the procedure of a print data registration process in step S702 in FIG. 7.

FIG. 9 is a flowchart showing the procedure of a user-identifying ID registration process in step S802 in FIG. 8.

FIGS. 10A and 10B are views showing examples of user selection screens displayed on the operating unit in FIG. 1.

FIG. 11 is a view showing an example of a setting screen displayed on the operating unit in FIG. 1.

FIG. 12 is a view useful in explaining an arrangement of user-identifying IDs under respective conditions in the present embodiment.

FIG. 13 is a flowchart showing the procedure of a first variation of the user-identifying ID registration process in FIG. 9.

FIG. 14 is a flowchart showing the procedure of a second variation of the user-identifying ID registration process in FIG. 9.

FIGS. 15A and 15B are views showing examples of attention-drawing screens displayed on the operating unit in FIG. 1.

### DESCRIPTION OF THE EMBODIMENTS

An embodiment of the present invention will now be described in detail with reference to the accompanying drawings.

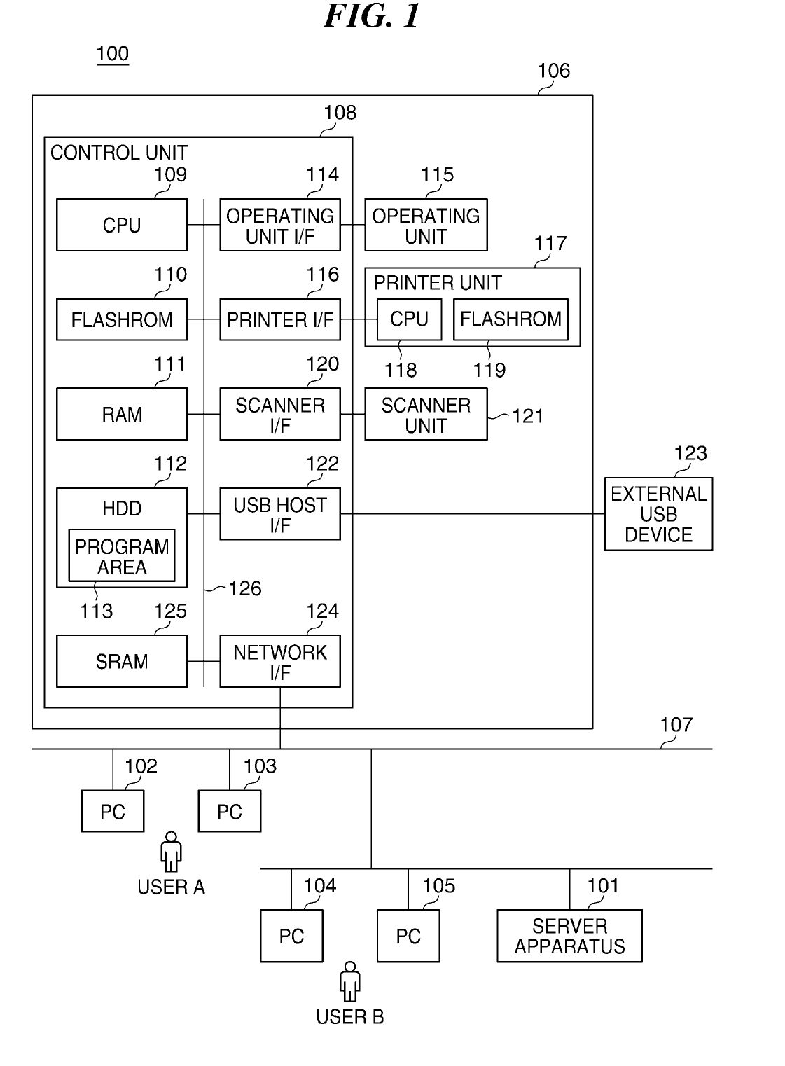

FIG. 1 is a network diagram schematically showing an arrangement of a printing system 100 including an MFP 106 which is an image forming apparatus according to the embodiment of the present invention.

The printing system 100 has a server apparatus 101, PCs 102 to 105, and the MFP 106. The server apparatus 101, the PCs 102 to 105, and the MFP 106 are connected to one another via a LAN 107. In the present embodiment, it is assumed that a user A uses the PCs 102 and 103, and a user B users the PCs 104 and 105.

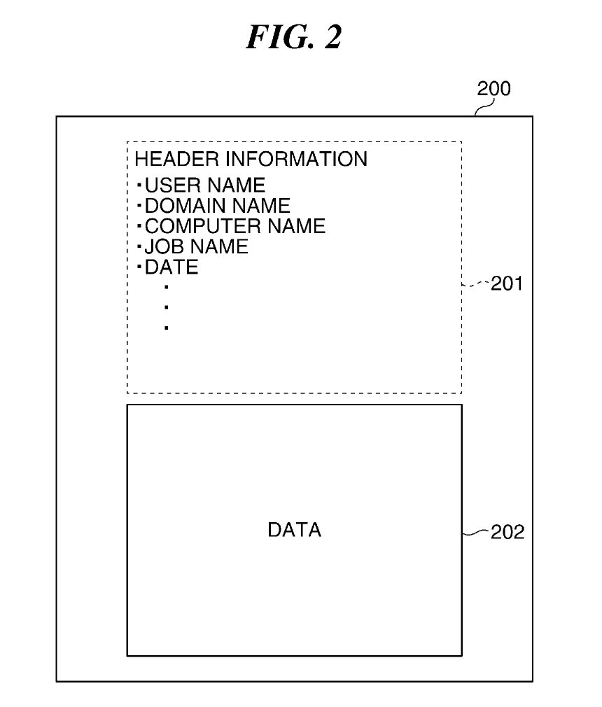

The server apparatus 101 is, for example, a domain controller for an active directory that offers a directory service. The server apparatus 101 manages domains of devices connected thereto via the LAN 107. In the present embodiment, the server apparatus 101 manages domains used by the PCs 104 and 105 among the PCs 102 to 105. As a result, uniqueness of the user B who uses the PCs 104 and 105 is ensured within domains managed by the server apparatus 101. Thus, a user name of the user B never matches user names of other users who use domains managed by the server apparatus 101. The PCs 102 to 105 send job data, for example, print data 200 in FIG. 2 for use in printing to the MFP 106 in accordance with instructions from the users. The print data 200 has header information 201 and actual data 202. The header information 201 includes user-related information such as information on a user who has given an instruction to send the print data 200 and information on a PC operated by the user. For example, print data sent from the PCs 102 and 103 that do not use the domains managed by the server apparatuses 101 includes a user name indicating the user and computer names indicating the PCs 102 and 103 as the user-related information. On the other hand, print data sent from the PCs 104 and 105 that use the domains managed by the server apparatuses 101 includes, as user-related information, a user name and computer names, and in addition, domain names indicating the domains used by the PCs 104 and 105. The actual data 202 includes a plurality of commands indicating details of printing. The MFP 106 executes jobs such as a scanning process and a printing process. The MFP 106 also performs reservation printing in which it temporarily holds the print data received from the PCs 102 to 105 and the like without immediately executing it, and in response to an instruction from a user, perform printing of the held print data.

A description will now be given of a hardware arrangement of the MFP 106.

The MFP 106 has a control unit 108, an operating unit 115, a printer unit 117, and a scanner unit 121. The control unit 108 is connected to the operating unit 115, the printer unit 117, and the scanner unit 121. The control unit 108 has a CPU 109, a flash ROM 110, a RAM 111, an HDD 112, an operating unit I/F 114, a printer I/F 116, a scanner I/F 120, a USB host I/F 122, a network I/F 124, and an SRAM 125. The CPU 109, the flash ROM 110, the RAM 111, the HDD 112, the operating unit I/F 114, the printer I/F 116, the scanner I/F 120, the USB host I/F 122, the network I/F 124, and the SRAM 125 are connected to one another via a system bus 126. The printer unit 117 has a CPU 118 and a flash ROM 119.

The control unit 108 integratedly controls the entire MFP 106. The CPU 109 reads programs for the control unit 108, which are stored in the flash ROM 110, and programs, which are stored in a program area 113 of the HDD 112, into the RAM 111 and executes them. For example, the CPU 109 executes an application program for printing, which is stored in the HDD 112, to convert the print data 200 or the like stored in the HDD 112 to into image data printable by the printer unit 117. The CPU 109 also executes an application program for scanning, which is stored in the HDD 112, to control an image data reading process carried out by the scanner unit 121, and transfers read image data to the HDD 112.

The flash ROM 110 stores, for example, programs to be used by the control unit 108. The RAM 111 is used as a work area for the CPU 109 and also as a temporary storage area for various pieces of data. The HDD 112 stores the print data 200 received from the PCs 102 to 105 via the network I/F 124, image data obtained as a result of conversion by the CPU 109, and so forth. The operating unit I/F 114 transfers an instruction, which is input by a user operating the operating unit 115, to the CPU 109. The operating unit I/F 114 also receives a display switching instruction for switching displays on the operating unit 115 from the CPU 109 and transfers the received display switching instruction to the operating unit 115.

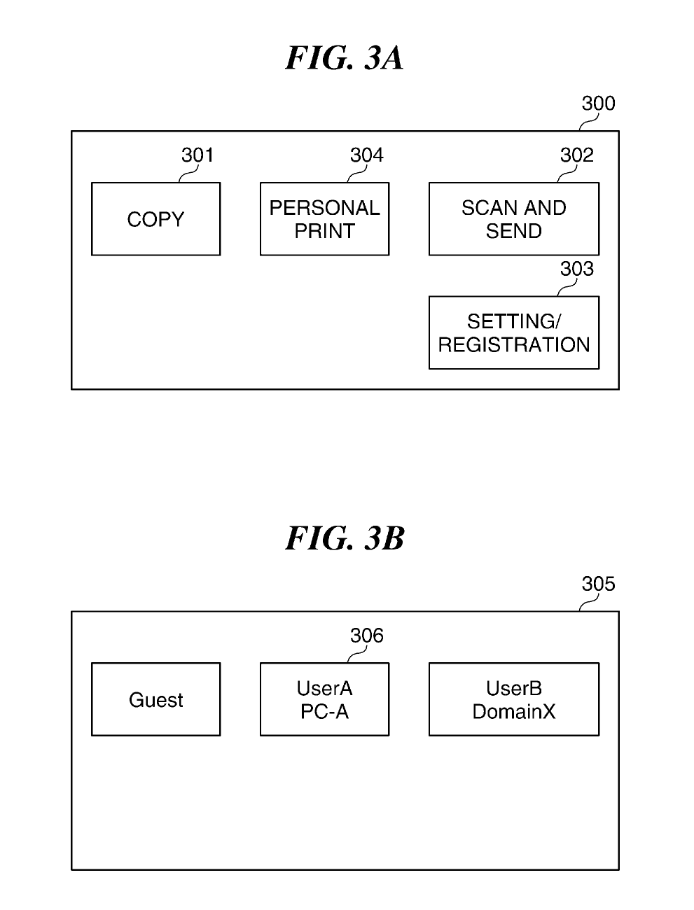

The operating unit 115 has a display unit and a plurality of operating keys, not shown. The operating unit 115 displays an operating screen 300 in FIG. 3A or the like on the display unit to receive executing instructions for jobs. The operating screen 300 has a copy button 301, a scan and send button 302, a setting/registration button 303, and a personal print button 304. The copy button 301 is an operating button for giving an instruction to carry out a copying process. The scan and send button 302 is an operating button for giving an instruction to scan in image data by means of the scanner 121 and giving an instruction to send the scanned-in image data to an external apparatus by email or the like. The setting/registration button 303 is an operating button for giving an instruction to switch the display on the operating unit 115 from the operating screen 300 to a screen for making settings on the MFP 106. The personal print button 304 is an operating button for giving an instruction to switch the display on the operating unit 115 from the operating screen 300 to a screen for giving an instruction to execute print data that is being held. When the personal print button 304 is selected, a user selection screen 305 in FIG. 3B is displayed on the operating unit 115. User icons for respective users are displayed on the user selection screen 305. When, for example, a user icon 306 is selected on the user selection screen 305, information on a list of print data sent to the MFP 106 by a user corresponding to the user icon 306 among multiple pieces of print data held in the MFP 106 is displayed on the operating unit 115. The user is able to select desired print data from the displayed print data and give an instruction to execute the selected print data.

The printer I/F 116 is an I/F for connecting the control unit 108 and the printer unit 117 together. The printer unit 117 is caused to carry out the printing process by the CPU 118 executing a program stored in the flash ROM 119. In the printing process, the printer unit 117 prints image data, which has been obtained from the HDD 112 via the printer I/F 116, on a sheet. The scanner I/F 120 is an I/F for connecting the control unit 108 and the scanner unit 121 together. The scanner unit 121 scans in an image on an original as image data by means of a line sensor comprised of a CCD (charge-coupled device) or the like. The scanner unit 121 also transfers the scanned-in image data to the HDD 112 via the scanner I/F 120. The USB host I/F 122 is an I/F for connecting the control unit 108 and an external USB device 123 together. The external USB device 123 is a USB memory, a USB keyboard, or the like. The network I/F 124 connects the control unit 108 to the LAN 107. The network I/F 124 carries out communications with the PCs 102 to 105 and the server apparatus 101 on the LAN 107. The SRAM 125 stores, for example, setting values for the MFP 106.

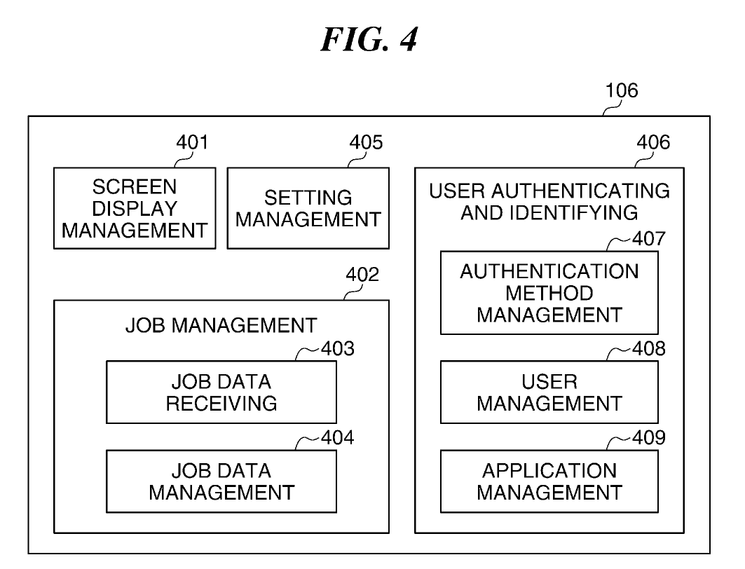

FIG. 4 is a block diagram schematically showing an arrangement of software modules of the MFP 106 in FIG. 1.

Referring to FIG. 4, the MFP 106 has a screen display management module 401, a job management module 402, a setting management module 405, and a user authenticating and identifying module 406. The job management module 402 has a job data receiving module 403 and a job data management module 404. The user authenticating and identifying module 406 has an authentication method management module 407, a user management module 408, and an application management module 409. Processing by the modules is implemented by the CPU 109 executing programs stored in the flash ROM 110 and the HDD 112.

The screen display management module 401 controls display on the operating unit 115. The job management module 402 manages the print data 200 received by the MFP 106. The job data receiving module 403 analyzes the header information 201 of the print data 200 received by the MFP 106. The job data management module 404 obtains information required to create the user-identifying ID from the header information 201 of the print data 200 and generates the user-identifying ID comprised of the obtained information. For example, when “UserA” and “PC-A” are set as a user name and a computer name, respectively, in the header information 201 of the received print data 200, the job data management module 404 generates a user-identifying ID “UserA@PC-A” based on the user name and the computer name. The setting management module 406 collectively manages settings on the MFP 106.

The user authenticating and identifying module 406 controls execution of user authentication performed in the MFP 106. The authentication method management module 407 manages which of the following authentication methods will be used to run a system: “user authentication is not applied”, “authentication is always requested to use a device (device authentication)”, “authentication is requested when an application that requires authentication is selected (perform authentication when a function is selected)”.

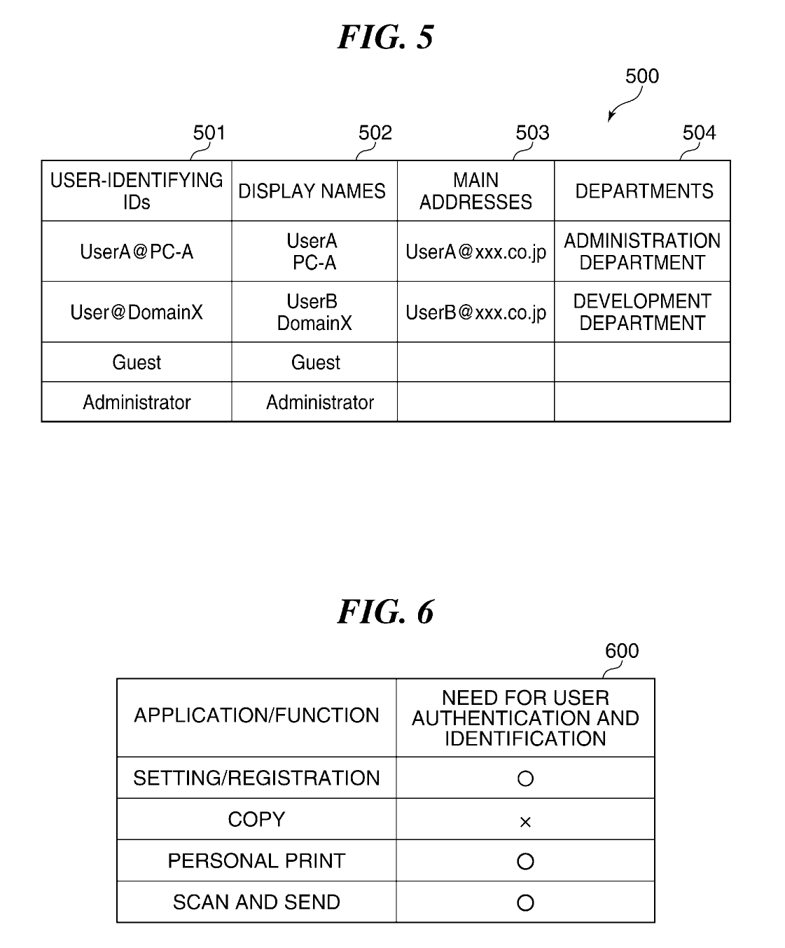

The user management module 408 manages user management information 500 in FIG. 5. The user management information 500 has user-identifying IDs 501, display names 502, mail addresses 503, and departments 504. The user-identifying IDs 501 are character strings that represent generated user-identifying IDs. The display names 502 are character strings displayed on user icons for the generated user-identifying IDs. For example, in the present embodiment, for a user-identifying ID “UserA@PC-A”, a character string obtained by deleting @ from it and inserting a return or by replacing @ with a space is set as the display name 502. The mail addresses 503 are mail addresses of users corresponding to the generated user-identifying IDs. The departments 504 are department names indicating departments to which the users corresponding to the generated user-identifying IDs belong. It should be noted that the information on the display names 502, the mail addresses 503, and the departments 504 in the user management information 500 are allowed to be registered and edited by the users operating the operating unit 115, but the information on the user-identifying IDs 501 is not allowed to be registered or edited by the users. This ensures uniqueness of user-identifying IDs generated in the MFP 106. In the present embodiment, authentication passwords for authenticating user information obtained from the users are associated with the information on the user-identifying IDs 501. As a result, when a user authentication function of the MFP 106 is enabled, the information on the user-identifying IDs 501 is allowed to be used as authentication IDs for authenticating user information obtained from the users.

The application management module 409 manages a management list 600 in FIG. 6. The management list 600 is a list for managing applications that require user authentication and user identification when the authentication method “perform authentication when a function is selected” is selected by the authentication method management module 407. In FIG. 6, for example, user authentication and user identification are required when the applications “personal print”, “scan and send”, and “setting/registration” are used. User authentication and user identification are not required when the application “copy” is used. It should be noted that in the present embodiment, both user authentication and user identification are performed when the authentication function is enabled, whereas only user identification is performed when the authentication function is disabled.

A description will now be given of reservation printing by the printing system 100.

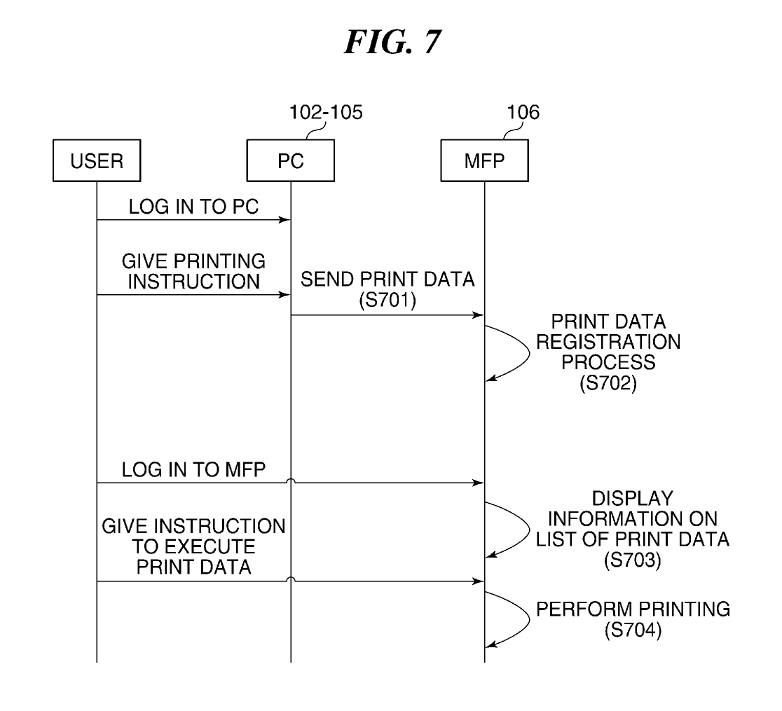

FIG. 7 is a timing chart showing the procedure of a reservation printing process that is carried out by the printing system 100 in FIG. 1.

Referring to FIG. 7, when a user logs in to one of the PCs 102 to 105 and gives a printing instruction to the PC to which the user logs in, the PC sends the print data 200 to the MFP 106 (step S701).

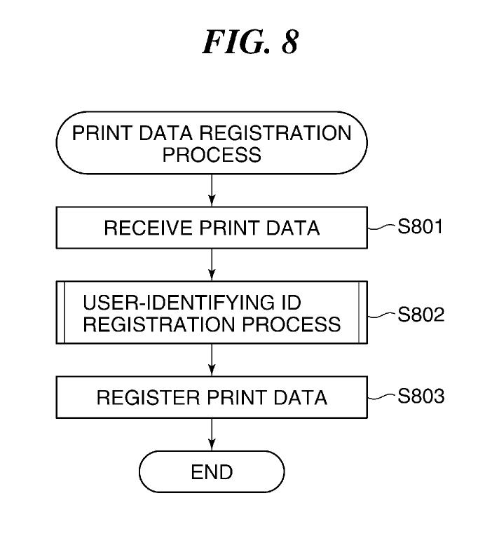

On the other hand, the MFP 106 carries out a print data registration process in FIG. 8, to be described later, to register the received print data 200 (step S702). Then, the MFP 106 carries out a login process in response to a login request from the user who has given the printing instruction. After that, the MFP 106 displays the user selection screen 305 on the operating unit 115 when the personal print button 304 is selected by the user who has logged in to the MFP 106 (hereafter referred to as “the MFP logged-in user”) on the operating screen 300 displayed on the operating unit 115. The MFP 106 displays information on a list of print data relating to a user icon selected by the MFP logged-in user on the user selection screen 305 (step S703). Then, upon receiving an instruction to execute print data selected by the MFP logged-in user, the MFP 106 performs printing on a sheet based on the selected print data (step S704) and ends the present process.

FIG. 8 is a flowchart showing the procedure of the print data registration process in the step S702 in FIG. 7.

The process in FIG. 8 is implemented by the CPU 109 executing programs stored in the flash ROM 110 and the HDD 112.

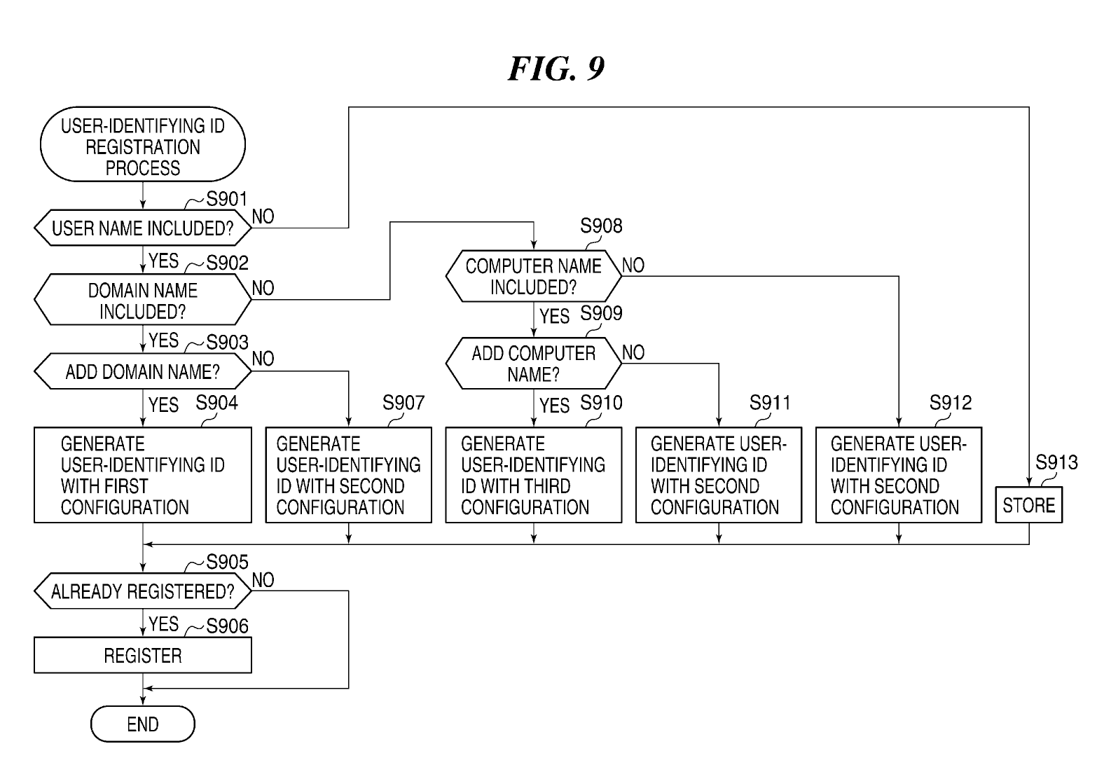

Referring to FIG. 8, the CPU 109 receives the print data 200 from the PC (step S801). Then, the CPU 109 carries out a user-identifying ID registration process in FIG. 9, to be described later (step S802) and registers a user-identifying ID generated based on the print data 200. After that, the CPU 109 registers the print data 200 as print data for performing reservation printing (step S803) and ends the present process.

FIG. 9 is a flowchart showing the procedure of the user-identifying ID registration process in the step S802 in FIG. 8.

In the printing system 100, the MFP 106 is used by not only the user B and the like for which uniqueness of their user names is managed within a domain managed by the server apparatus 101 but also the user A who does not use that domain. In a case where a user name of the user A is not managed by a method other than the method using a domain such that it does not match user names of respective other users who use the MFP 106, for example, user names of the user A and the user B may match each other. In this case, a problem that print data sent by the user A is associated with a user-identifying ID of the user B arises. For this reason, in an environment where uniqueness of user names of all users who use the MFP 106 is not managed, a user-identifying ID needs to include a domain name or a computer name as well as a user name.

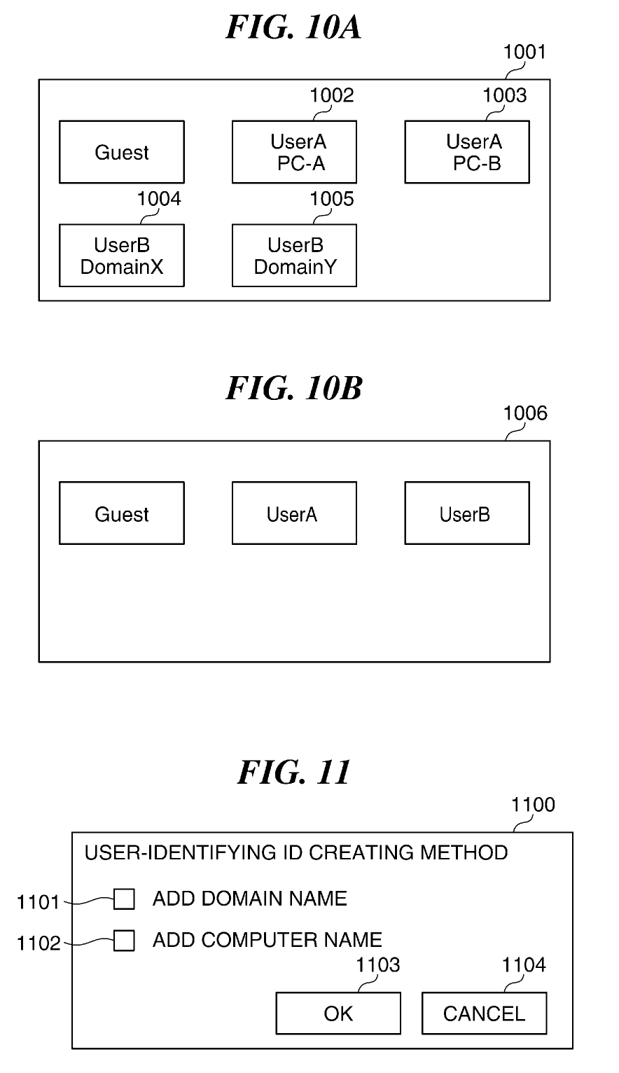

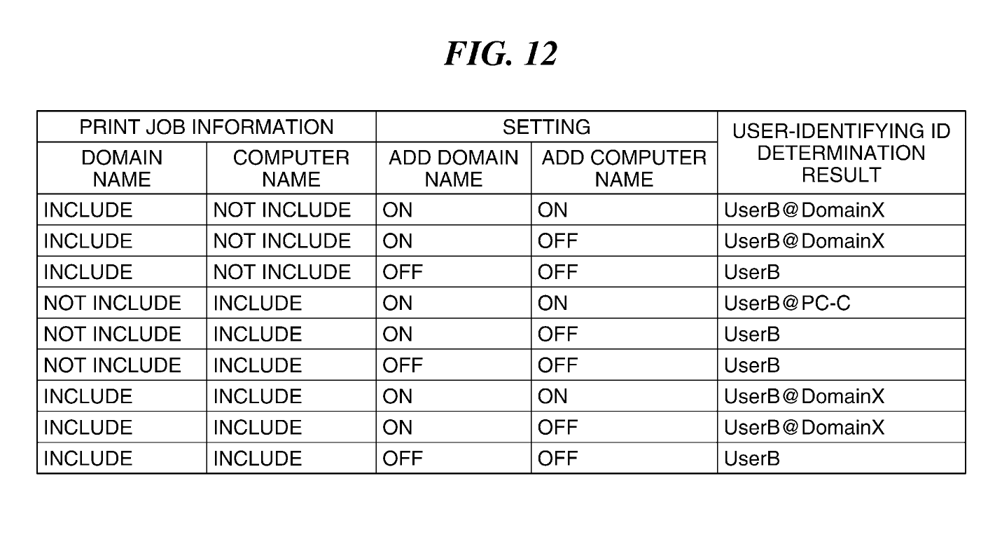

On the other hand, in a case where the user name of the user A is managed by a method other than the method using a domain such that it does not match user names of respective other users who use the MFP 106, for example, the user name of the user A never matches user names of other uses who use the MFP 106. In this case, even if a user-identifying ID comprised of only a user name is used, uniqueness of each user is ensured. Rather than that, in this case, if a user-identifying ID including a domain name and a computer name is used, and the same user uses different domains and different PCs, a plurality of user-identifying IDs would be generated for the respective domains and PCs. As a result, a plurality of user icons for the same user corresponding to respective user-identifying IDs like user icons 1002 and 1003 and user icons 1004 and 1005 in FIG. 10A are displayed on the operating unit 115, and hence the user icons are displayed in a complicated manner. Thus, in an environment where uniqueness of user names of all users who use the MFP 106 is managed, a user-identifying ID comprised of only a user name needs to be generated so as to prevent unnecessary user-identifying IDs from being generated for the same user. In recent years, there has been a high demand for MFPs capable of generating user-identifying IDs suitable for each of the above described environments.

Accordingly, in the present embodiment, when the received print data 200 includes a domain name (computer name) and a user name, a user-identifying ID comprised of the domain name (computer name) and the user name or a user-identifying ID comprised of only the user name is generated based on setting information configured on a setting screen 1100 in FIG. 11, to be described later.

Referring to FIG. 9, the CPU 109 analyzes the header information 201 of the received print data 200 by means of the job data receiving module 403 and determines whether or not the user name is included in the header information 201 (step S901).

As a result of the determination in the step S901, when the user name is included in the header information 201, the CPU 109 determines whether or not the domain name is included in the header information 201 (step S902).

As a result of the determination in the step S902, when the domain name is included in the header information 201, the CPU 109 reviews setting information on the setting screen 1100 in FIG. 11 on which a configuration of a user-identifying ID is set. Only an administrator is allowed to operate the setting screen 1100. The setting screen 1100 has checkboxes 1101 and 1102, an OK button 1103, and a cancel button 1104. With the checkbox 1101, whether or not to add the domain name to the user-identifying ID is selected. When the checkbox 1101 is set to on, a setting that will add the domain name to the user-identifying ID is made. On the other hand, when the checkbox 1101 is set to off, a setting that will not add the domain name to the user-identifying ID is made. The checkbox 1102 is allowed to be set to on or off only when the checkbox 1101 is set to on, and with the checkbox 1102, whether or not to add the computer name to the user-identifying ID is selected. When the checkbox 1102 is set to on, a setting that will add the computer name to the user-identifying ID is made. On the other hand, when the checkbox 1102 is set to off, a setting that will not add the computer name to the user-identifying ID is made. When the settings are made with the checkboxes 1101 and 1102, and then the OK button 1103 is selected, the CPU 109 saves the setting information on the checkboxes 1101 and 1102. On the other hand, when the settings are made with the checkboxes 1101 and 1102, and then the cancel button 1104 is selected, the CPU 109 resets the settings on the checkboxes 1101 and 1102. The CPU 109 also closes the setting screen 1100. The CPU 109 determines whether or not the checkbox 1101 on the setting screen 1100 is on, that is, whether or not the setting that will add the domain name to the user-identifying ID is made (step S903).

As a result of the determination in the step S903, when the setting that will add the domain name to the user-identifying ID is made, the CPU 109 generates the user-identifying ID with a first configuration comprised of the user name and the domain name included in the header information 201 of the print data 200 (step S904). Then, the CPU 109 determines whether or not the generated user-identifying ID has already been registered in the user management information 500 (step S905).

As a result of the determination in the step S905, when the generated user-identifying ID has already been registered in the user management information 500, the CPU 109 ends the present process. As a result of the determination in the step S905, when the generated user-identifying ID has not yet been registered in the user management information 500, the CPU 109 registers the generated user-identifying ID in the user management information 500 (step S906) and ends the present process.

As a result of the determination in the step S903, when the setting that will add the domain name to the user-identifying ID is not made (for example, the checkbox 1101 is off), the CPU 109 generates the user-identifying ID with a second configuration comprised of only the user name included in the header information 201 of the print data 200 (step S907). After that, the CPU 109 carries out the processes in the step S905 and the subsequent steps.

As a result of the determination in the step S902, when no domain name is included in the header information 201, the CPU 109 determines whether or not the computer name is included in the header information 201 (step S908).

As a result of the determination in the step S908, when the computer name is included in the header information 201, the CPU 109 determines whether or not the checkbox 1102 on the setting screen 1100 is on, that is, whether the setting that will add the computer name to the user-identifying ID is made (step S909).

As a result of the determination in the step S909, when the setting that will add the computer name to the user-identifying ID is made, the CPU 109 generates the user-identifying ID with a third configuration comprised of the user name and the computer name included in the header information 201 of the print data 200 (step S910). After that, the CPU 109 carries out the processes in the step S905 and the subsequent steps.

As a result of the determination in the step S909, when the setting that will add the computer name to the user-identifying ID is not made (for example, the checkbox 1102 is off), the CPU 109 generates the user-identifying ID with the second configuration (step S911). After that, the CPU 109 carries out the processes in the step S905 and the subsequent steps.

As a result of the determination in the step S908, when no computer name is included in the header information 201, the CPU 109 generates the user-identifying ID with the second configuration (step S912) and carries out the processes in the step S905 and the subsequent steps. Thus, in the present embodiment, user-identifying IDs with different configurations suitable for office environments are generated based on setting information on the setting screen 1100 and user-related information included in print data. For example, when uniqueness of user names of all users who use the MFP 106 is not managed, the checkboxes 1101 and 1102 are set to on, and unique user-identifying IDs including domain names or computer names as well as user names are generated for the respective users. On the other hand, when uniqueness of user names of all users who use the MFP 106 is managed, the checkboxes 1101 and 1102 are set to off, and user-identifying IDs comprised of only user names are generated for the respective users.

As a result of the determination in the step S901, when no user name is included in the header information 201, the CPU 109 stores the print data 200 as print data associated with no user (step S913) and then carries out the processes in the step S905 and the subsequent steps. After that, user icons for the registered user-identifying IDs are generated in the MFP 106. The generated user icons are displayed on the operating unit 115 when the user has selected the personal print button 304 on the operating screen 300. For example, when the checkboxes 1101 and 1102 are set to off, a user selection screen 1006 in FIG. 10B is displayed on the operating unit 115 based on the registered user-identifying IDs. On the user selection screen 1006, different user icons are not displayed for the same user unlike the user selection screen 1001, and therefore, the user icons are displayed in an uncomplicated manner.

According to the present embodiment described above, when the received print data 200 includes the domain name (computer name) and the user name, the user-identifying ID comprised of the domain name (computer name) and the user name or the user-identifying ID comprised of only the user name is generated based on setting information on the setting screen 1100. As a result, user-identifying IDs suitable for office environments which users are using are generated.

It should be noted that when a user name included in the header information 201 matches “Administrator” meaning an administrator of the MFP 106, the user-identifying ID comprised of the domain name (computer name) and the user name may be generated.

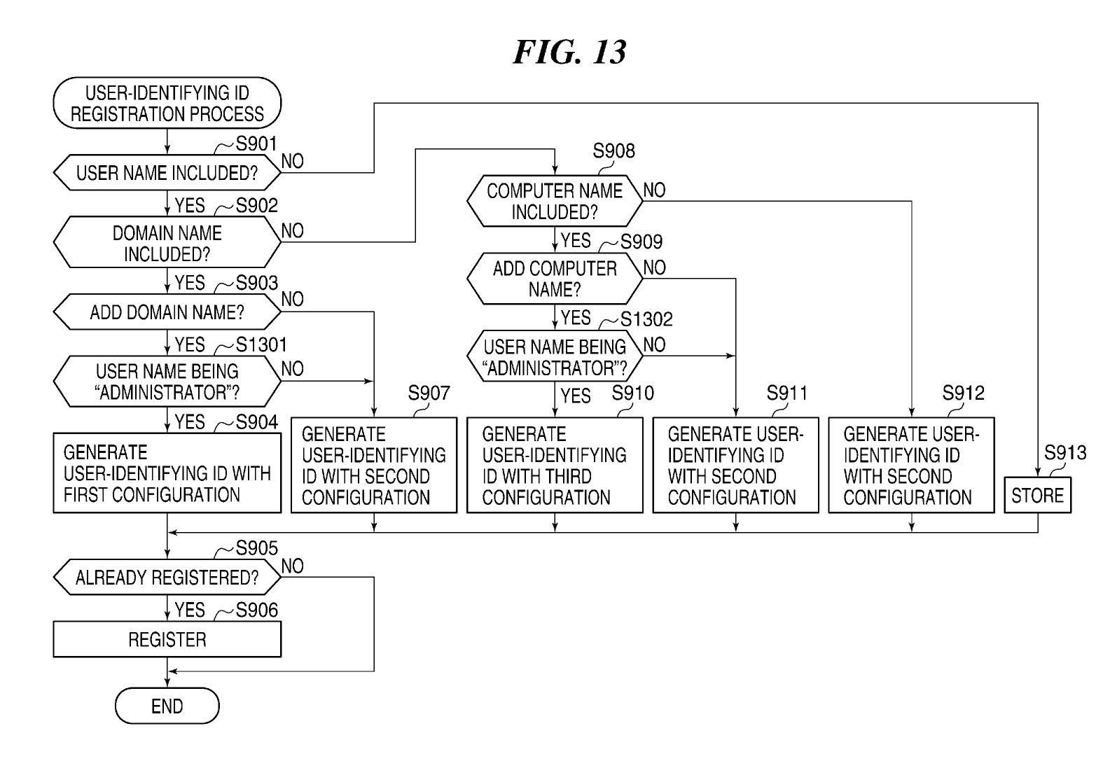

FIG. 13 is a flowchart showing the procedure of a first variation of the user-identifying ID registration process in FIG. 9.

The process in FIG. 13 differs from the process in FIG. 9 only in that a process in step S1301, to be described later, is carried out when the determination result in the step S903 is positive (YES), and a process in step S1302, to be described later, is carried out when the determination result in the step S909 is positive (YES). Therefore, only the processes in the steps S1301 and S1302 differing from the process in FIG. 9 will be described below.

As a result of the determination in the step S903, when the setting that will add the domain name to the user-identifying ID is made, the CPU 109 determines whether or not the user name included in the header information 201 is “Administrator” (step S1301).

As a result of the determination in the step S1301, when the user name included in the header information 201 is “Administrator”, the CPU 109 carries out the processes in the step S904 and the subsequent steps. As a result of the determination in the step S1301, when the user name included in the header information 201 is not “Administrator”, the CPU 109 carries out the processes in the step S907 and the subsequent steps.

As a result of the determination in the step S909, when the setting that will add the computer name to the user-identifying ID is made, the CPU 109 determines whether or not the user name included in the header information 201 is “Administrator” (step S1302).

As a result of the determination in the step S1302, when the user name included in the header information 201 is “Administrator”, the CPU 109 carries out the processes in the step S910 and the subsequent steps. As a result of the determination in the step S1302, when the user name included in the header information 201 is not “Administrator”, the CPU 109 carries out the processes in the step S911 and the subsequent steps.

In the process in FIG. 13 described above, when the user name included in the header information 201 is “Administrator”, the user-identifying ID comprised of a domain name (computer name) and the user name is generated. In general, “Administrator” is widely used as a user name of an administrator for a system or a device. For this reason, there may be cases where a user different from the administrator of the MFP 106 is an administrator of an apparatus or a system other than the MFP 106 and uses “Administrator” as a user name. In this case, if a user-identifying ID comprised of only “Administrator” is generated, a problem that print data sent by a plurality of different users is associated with the generated user-identifying ID arises. To solve this problem, when a user name included in the header information 201 is “Administrator”, the user-identifying ID comprised of the domain name (computer name) and the user name is generated. As a result, for a user with a user name “Administrator”, a unique user-identifying ID is generated, and this prevents occurrence of a problem that print data sent by a plurality of users is associated with the generated user-identifying ID.

In the present embodiment described above, when the user name included in the header information 201 matches a user name of a user who has an administrator right for the MFP 106, the user-identifying ID comprised of the domain name (computer name) and the user name may be generated.

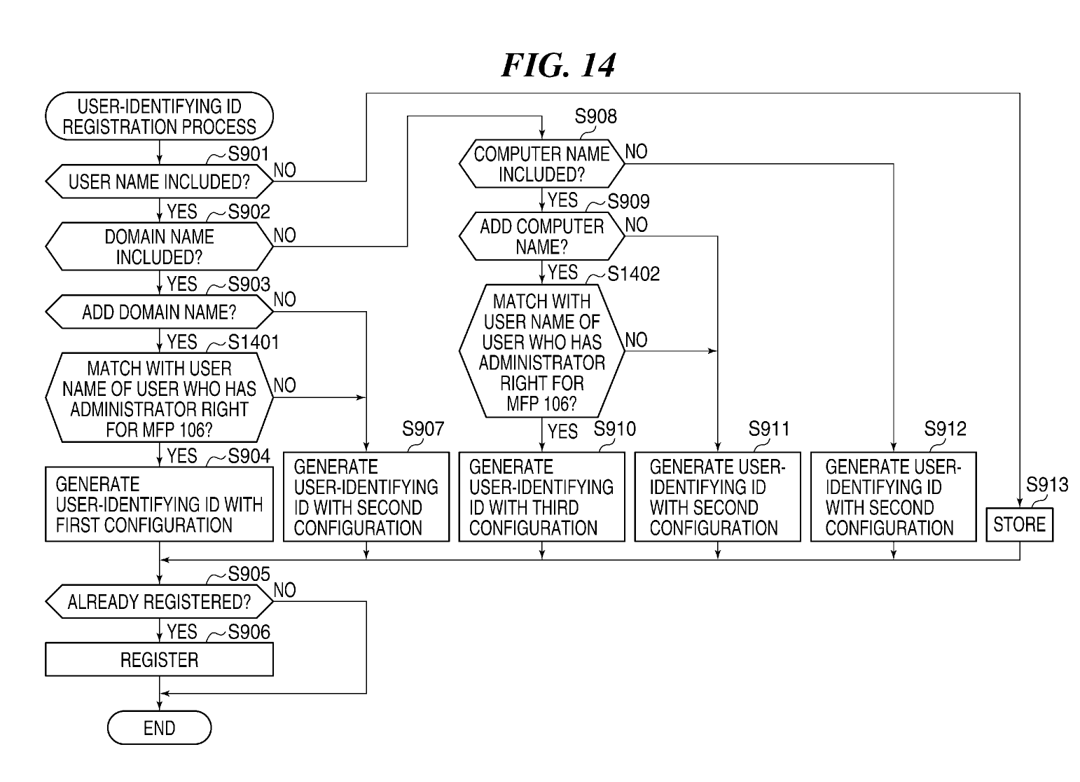

FIG. 14 is a flowchart showing the procedure of a second variation of the user-identifying ID registration process in FIG. 9.

The process in FIG. 14 differs from the process in FIG. 9 only in that a process in step S1401, to be described later, is carried out when the determination result in the step S903 is positive (YES), and a process in step S1402, to be described later, is carried out when the determination result in the step S909 is positive (YES). For this reason, only the processes in the steps S1401 and S1402 differing from the process in FIG. 9 will be described below.

As a result of the determination in the step S903, when the setting that will add the domain name to the user-identifying ID is made, the CPU 109 determines whether or not the user name included in the header information 201 matches the user name of the user who has the administrator right for the MFP 106 (step S1401).

As a result of the determination in the step S1401, when the user name included in the header information 201 matches the user name of the user who has the administrator right for the MFP 106, the CPU 109 carries out the processes in the step S904 and the subsequent steps. As a result of the determination in the step S1401, when the user name included in the header information 201 does not match the user name of the user who has the administrator right for the MFP 106, the CPU 109 carries out the processes in the step S907 and the subsequent steps.

As a result of the determination in the step S909, when the setting that will add the computer name to the user-identifying ID is made, the CPU 109 determines whether or not the user name included in the header information 201 matches the user name of the user who has the administrator right for the MFP 1066 (step S1402).

As a result of the determination in the step S1402, when the user name included in the header information 201 matches the user name of the user who has the administrator right for the MFP 106, the CPU 109 carries out the processes in the step S910 and the subsequent steps. As a result of the determination in the step S1402, when the user name included in the header information 201 does not match the user name of the user who has the administrator right for the MFP 106, the CPU 109 carries out the processes in the step S911 and the subsequent steps.

In the process in FIG. 14 described above, when the user name included in the print data 200 matches the user name of the user who has the administrator right for the MFP 106, the user-identifying ID comprised of the domain name (computer name) and the user name is generated. This prevents the same user-identifying ID as that of the user who has the administrator right for the MFP 106 from being generated. It is thus possible to prevent a situation in which a user different from the user who has the administrator right for the MFP 106 from using the same user-identifying ID as that of the user who has the administrator right for the MFP 106 and inadvertently changing settings on the MFP 106.

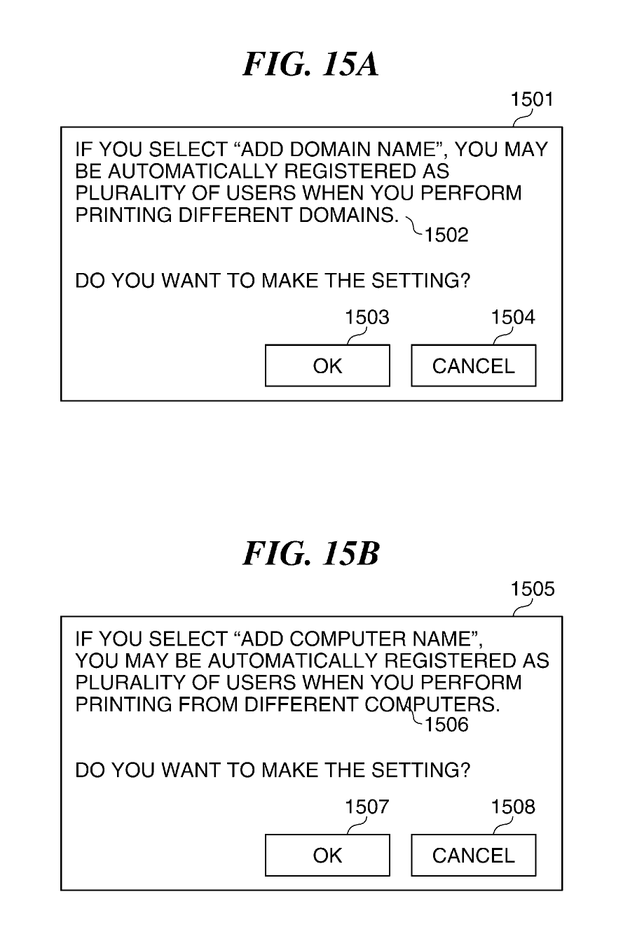

Moreover, in the present embodiment described above, to provide notification that draws attention when the checkboxes 1101 are 1102 are set to on, attention-drawing screens 1501 and 1505 may be displayed on the operating unit 115 in FIGS. 15A and 15B, respectively. The attention-drawing screens 1501 and 1505 include messages 1502 and 1506, respectively, saying that a plurality of user-identifying IDs will be automatically generated even for the same user when the checkboxes 1101 and 1102 are set to on. When OK buttons 1503 and 1507 are selected, the display on the operating unit 115 switches to the setting screen 1100 on which the checkboxes 1101 and 1102 are on. On the other hand, when cancel buttons 1504 and 1508 are selected, the display on the operating unit 115 switches to the setting screen 1100 on which the checkboxes 1101 and 1102 are off. By thus displaying the attention-drawing screens 1501 and 1505 on the operating unit 115, the operator (the administrator of the MFP 106) is notified of a risk involved in turning the checkboxes 1101 and 1102 on before setting information indicating the checkboxes 1101 and 1102 set on is reflected in the MFP 106.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-125225, filed Jun. 27, 2017, which is hereby incorporated by reference herein in its entirety.

What is claimed is:

1. An image forming apparatus that holds job data received from an external apparatus operated by a user, and in accordance with an instruction given by the user, executes the job data, comprising:
a generating unit configured to, based on user-related information related to the user and included in the received job data, generate a user-identifying ID for managing the job data; and
a setting unit configured to prompt the user to set setting information relating to a configuration of the user-identifying ID,
wherein in a case where the received job data includes a domain name indicating a domain used by the external apparatus and a user name indicating the user who has operated the external apparatus as the user-related information, the generating unit generates a first user-identifying ID comprising the domain name and the user name or a second user-identifying ID comprising only the user name based on the setting information.

2. An image forming apparatus that holds job data received from an external apparatus operated by a user, and in accordance with an instruction given by the user, executes the job data, comprising:
a generating unit configured to, based on user-related information related to the user and included in the received job data, generate a user-identifying ID for managing the job data; and
a setting unit configured to prompt the user to set setting information relating to an arrangement of the user-identifying ID,
wherein in a case where the received job data includes a computer name indicating the external apparatus and a user name indicating the user who has operated the external apparatus as the user-related information, the generating unit generates a first user-identifying ID comprising the computer name and the user name or a second user-identifying ID comprising only the user name based on the setting information.

3. The image forming apparatus according to claim 1, wherein in a case where the user name included the received job data is “Administrator”, the generating unit generates the first user-identifying ID.

4. The image forming apparatus according to claim 1, wherein in a case where the user name included the received job data matches a user name indicating a user who has an administrator right for the image forming apparatus, the generating unit generates the first user-identifying ID.

5. The image forming apparatus according to claim 1, further comprising a notification unit configured to, in a case where the setting information represents a configuration of the first user-identifying ID, provide an attention-drawing notification that a plurality of user-identifying IDs will be generated for the same user.

6. A control method for an image forming apparatus that holds job data received from an external apparatus operated by a user, and in accordance with an instruction given by the user, executes the job data, comprising:
a generating step of, based on user-related information related to the user and included in the received job data, generating a user-identifying ID for managing the job data; and
a setting step of prompting the user to set setting information relating to a configuration of the user-identifying ID,
wherein in a case where the received job data includes a domain name indicating a domain used by the external apparatus and a user name indicating the user who has operated the external apparatus as the user-related information, a first user-identifying ID comprising the domain name and the user name or a second user-identifying ID comprising only the user name is generated based on the setting information in the generating step.

7. A control method for an image forming apparatus that holds job data received from an external apparatus operated by a user, and in accordance with an instruction given by the user, executes the job data, comprising:
a generating step of, based on user-related information related to the user and included in the received job data, generating a user-identifying ID for managing the job data; and
a setting step of prompting the user to set setting information relating to a configuration of the user-identifying ID,
wherein in a case where the received job data includes a computer name indicating the external apparatus and a user name indicating the user who has operated the external apparatus as the user-related information, a first user-identifying ID comprising the computer name and the user name or a second user-identifying ID comprising only the user name is generated based on the setting information in the generating step.

8. A non-transitory computer-readable storage medium storing a program for causing a computer to execute a control method for an image forming apparatus that holds job data received from an external apparatus operated by a user, and in accordance with an instruction given by the user, executes the job data, the control method for the mage forming apparatus comprising:
a generating step of, based on user-related information related to the user and included in the received job data, generating a user-identifying ID for managing the job data; and
a setting step of prompting the user to set setting information relating to a configuration of the user-identifying ID,
wherein in a case where the received job data includes a domain name indicating a domain used by the external apparatus and a user name indicating the user who has operated the external apparatus as the user-related information, a first user-identifying ID comprising the domain name and the user name or a second user-identifying ID comprising only the user name is generated based on the setting information in the generating step.

9. A non-transitory computer-readable storage medium storing a program for causing a computer to execute a control method for an image forming apparatus that holds job data received from an external apparatus operated by a user, and in accordance with an instruction given by the user, executes the job data, the control method for the mage forming apparatus comprising:
a generating step of, based on user-related information related to the user and included in the received job data, generating a user-identifying ID for managing the job data; and
a setting step of prompting the user to set setting information relating to a configuration of the user-identifying ID,
wherein in a case where the received job data includes a computer name indicating the external apparatus and a user name indicating the user who has operated the external apparatus as the user-related information, a first user-identifying ID comprising the computer name and the user name or a second user-identifying ID comprising only the user name is generated based on the setting information in the generating step.
